(19) United States
(12) Patent Application Publication
(10) Pub. No.: US 2009/0102991 A1
(43) Pub. Date: Apr. 23, 2009

(54) Liquid Crystal Display Panel

(75) Inventors: Yung-Jen Chen, Hsin-Chu (TW); Jung-Ching Chen, Hsin-Chu (TW); Chia-Hsuan Lin, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 11/956,519

(22) Filed: Dec. 14, 2007

(30) Foreign Application Priority Data
Oct. 23, 2007 (TW) 96139765

(51) Int. Cl. G02F 1/133

(52) U.S. Cl. 349/33

(57) ABSTRACT

A liquid crystal display panel is provided. The liquid crystal display panel includes a plurality of pixel units, a first common voltage region and a second common voltage region. The pixel units include a first group of pixel units and a second group of pixel units arranged in rows and columns. The first common voltage region carries a first alternating current thereon and is electrically connected to the first group of pixel units. The second common voltage region carries a second alternating current thereon and is electrically connected to the second group of pixel units.

### RELATED APPLICATIONS

This application claims priority to Taiwan Patent Application Serial Number 96139765, filed Oct. 23, 2007, which is herein incorporated by reference in its entirety.

### BACKGROUND

1. Field of Invention

The present invention relates to a liquid crystal display panel. More particularly, the present invention relates to a liquid crystal display panel with two common voltages.

2. Description of Related Art

The conventional liquid crystal display panel has an array structure of pixel units. FIG. 1 shows a top view of a conventional liquid crystal display panel. The conventional liquid crystal display panel 100 comprises a plurality of gate lines 102 and signal lines 104 that intersect to define a plurality of pixel units 106. The conventional liquid crystal display panel 100 further comprises a common voltage region 108 to provide direct current (DC) voltage or alternating current (AC) voltage to every pixel unit. The pixel units of the conventional liquid crystal display panel 100 have different inversion modes, such as row inversion, column inversion, and dot inversion. When the common voltage is a DC voltage, the source driver needs a high voltage process to satisfy the swing that the signal voltage adds on the common voltage. For example, FIG. 1A is a diagram illustrating the signal voltage that uses the common voltage as the DC voltage reference. When the common voltage Vcom is 5V, the data signal Data takes Vcom1 as a reference to swing up and down for 5V. Thus, the source driver should have at least a driving ability of 10V. This high voltage process will raise the price of the chip and cause higher temperatures and greater power dissipation of the source driver.

Furthermore, if the common voltage is an AC voltage, the inversion can be accomplished by smaller voltage swing in row inversion. For example, FIG. 1B shows signal voltage that uses the common voltage as the AC voltage reference. Take the X-th column of the pixel units as an example, the polarity of the common voltage and the signal voltage are opposite in the N-th frame. Thus, it only takes 5V of the range of swing to accomplish inversion. For example, when the common voltage is 0V in the (N+1)-th frame, the data signal can be 5V and thus the substantial voltage on the pixel capacitance is 5V. When the common voltage is 5V in the N-th frame, the data signal only takes 0V to make the substantial voltage on the pixel capacitance be −5V. Thus, the AC voltage can take only 5V to accomplish the inversion of the panel pixels.

Nevertheless, using the single common voltage region can only provide all the pixel units the same AC voltage. That is, it is only suitable for row inversion. If column inversion or dot inversion is adopted, the range of the driving voltage cannot be reduced. As shown in FIG. 1C, two signals with opposite polarity are input into the signal line in column inversion or dot inversion. Thus, the range of the driving voltage of the X-th column of the pixel units can be reduced by an AC voltage (e.g. 5V), but the signal of the pixel units of the neighboring (X+1)-th column has opposite polarity against the signal of the pixel units of X-th column. The common voltage does not reduce the range of the voltage. On the contrary, it increases the range of the voltage (e.g. the range of 15V between 10 v and −5V).

From the description above, it should be realized that using a single common voltage region cannot reduce the range of the driving voltage in column inversion or dot inversion.

### SUMMARY

The present invention provides a liquid crystal display panel that does not increase the range of the output voltage of the source driver in column inversion or dot inversion. The liquid crystal display panel comprises a plurality of pixel units, a first common voltage region and a second common voltage region. The plurality of pixel unit comprise a first group of pixel units and a second group of pixel units and are arranged in an array structure. The first common voltage carries a first AC voltage thereon and is electrically connected to the first group of pixel units. The second common voltage carries a second AC voltage thereon and is electrically connected to the second group of pixel units.

According to an embodiment of the present invention, two common voltage regions are used to apply two common voltages with opposite polarity to the corresponding pixel units. The two common voltages with opposite polarity are input to the first and the second group of pixel units so as to avoid the increase of the range of the driving voltage.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings where:

FIG. 1 is a top view of a conventional liquid crystal display panel;

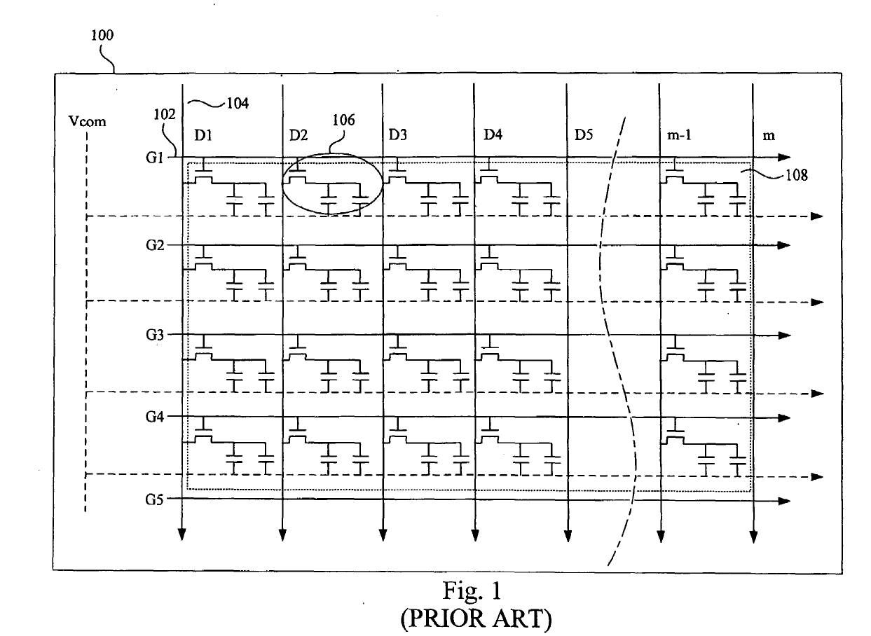

FIG. 1A is a diagram of the signal voltage that uses the common voltage as the DC voltage reference;

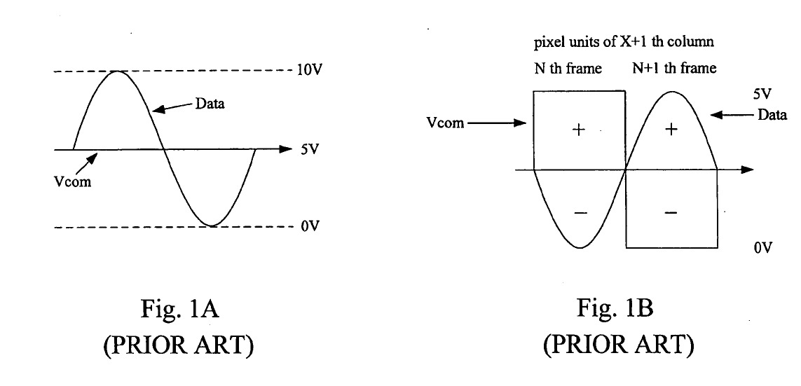

FIG. 1B is a diagram of the signal voltage that uses the common voltage as the AC voltage reference;

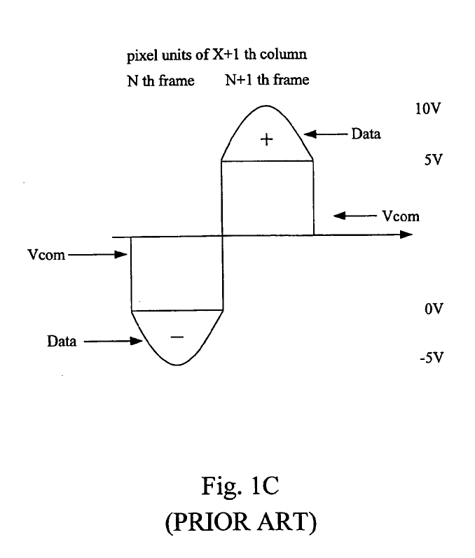

FIG. 1C is a diagram of the driving voltage of the X column of the pixel units;

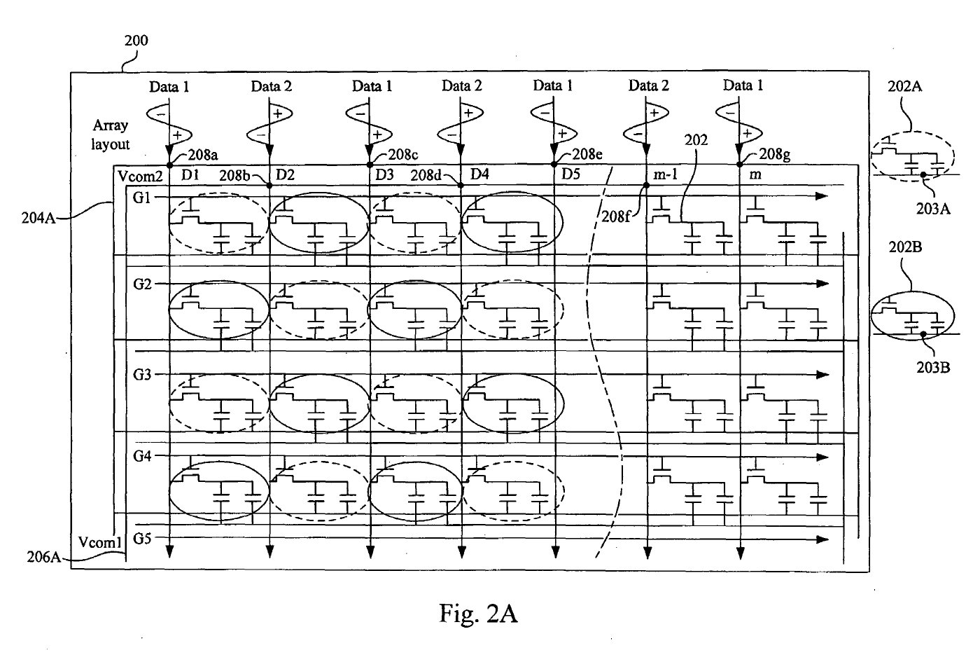

FIGS. 2A and 2B are top views of one embodiment of the present invention; and

FIGS. 3A and 3B are diagrams of the common voltage and signal of one embodiment of the present invention.

### DETAILED DESCRIPTION

Reference will now be made in detail to the present embodiments of the invention, examples of which are illustrated in the accompanying drawings. Wherever possible, the same reference numerals are used in the drawings and the description to refer to the same or like parts.

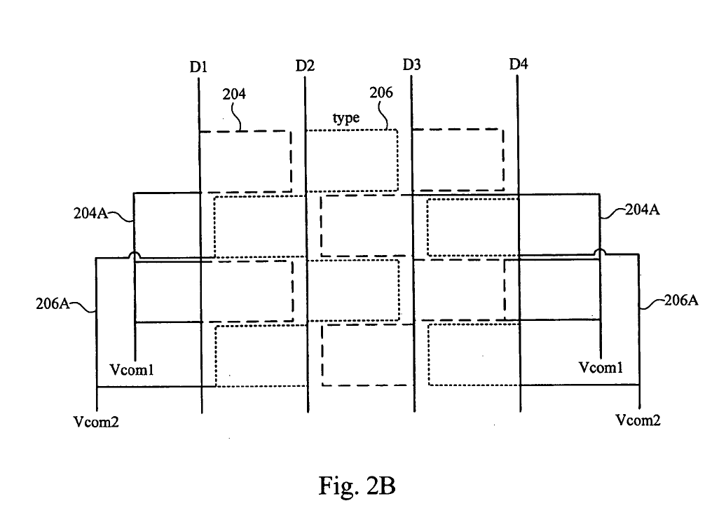

FIGS. 2A and 2B are two top views of an embodiment of the present invention. A liquid crystal display panel 200 comprises a plurality of pixel units 202, a first common voltage region 204, and a second common voltage region 206. As depicted in FIG. 2A, the pixel units 202 comprise a first group of pixel units 202A and a second group of pixel units 202B and are arranged in array structure. As depicted in FIG. 2B, the first common voltage region 204 on the pixel units 202 carries a first AC voltage (Vcom1) thereon and is electrically connected to the first group of pixel units 202A. The second common voltage region 206 carries a second AC voltage (Vcom2) thereon and is electrically connected to the second group of pixel units 202B.

In the present embodiment, the first group of pixel units 202A and the second group of pixel units 202B can be arranged in an interlaced manner, i.e. the pixels on the four neighboring sides of each pixel unit of the first group of pixel units 202A belong to the second group of pixel units 202B. Thus, the pixels in the same group are not next to each other. Furthermore, first common electrodes 203A of the capacitance f the first group of the pixel units 202A are electrically connected to a first conducting material, and second common electrodes 203B of the capacitance of a second group of pixel units are electrically connected to a second conducting material.

The first common voltage region 204 can be electrically connected to the capacitance common electrodes of the first group of the pixel units 202A through a first conducting material 204A. For example, the first common voltage region 204 is a conducting glass and the first conducting material 204A is a metal conducting wire. When the first conducting material 204A carries the voltage Vcom1 thereon, the first common voltage region 204 will carry Vcom1 as well. As a result, the first group of pixel units uses Vcom1 as the common voltage. Similarly, the second common voltage region 206 can be electrically connected to the capacitance common electrode of the second group of the pixel units 202B through a second conducting material 206A. The second common voltage region 206 is a conducting glass and the second conducting material 204B is a metal conducting wire. When the second conducting material 206A carries the voltage Vcom2, the second common voltage region 206 will carry Vcom2 as well, and the second group of pixel units uses Vcom2 as the common voltage. The first and the second common voltage regions 204 and 206 are electrically connected to the corresponding first conducting material 204A and the second conducting material 206A through transfer pads 208a, 208b, 208c, 208d, 208e, 208f, and 208g, for example.

Furthermore, the first common voltage region 204 and the second voltage region 206 can be placed on different metal layers of the liquid crystal display panel and may be electrically isolated. The first common voltage region 204 and the second voltage region 206 can be arranged in an interlaced manner on the corresponding first group of pixel units 202A and the corresponding second group of pixel units 202B.

The arrangement of the first common voltage region 204, the second voltage region 206, the first group of pixel units 202A and the second group of pixel units 202B can also be set according to column inversion or row inversion. For example, the first group of pixel units 202A can comprise the odd columns of pixel units 202 and the second group of pixel units 202B can comprise the even columns of pixel units 202, i.e. the first capacitance common electrode 203A of every one of the two neighboring column (row) of the pixel units is electrically connect to the first conducting material and the second capacitance common electrode 203B of the other column (row) of the pixel unit is electrically connect to the second conducting material.

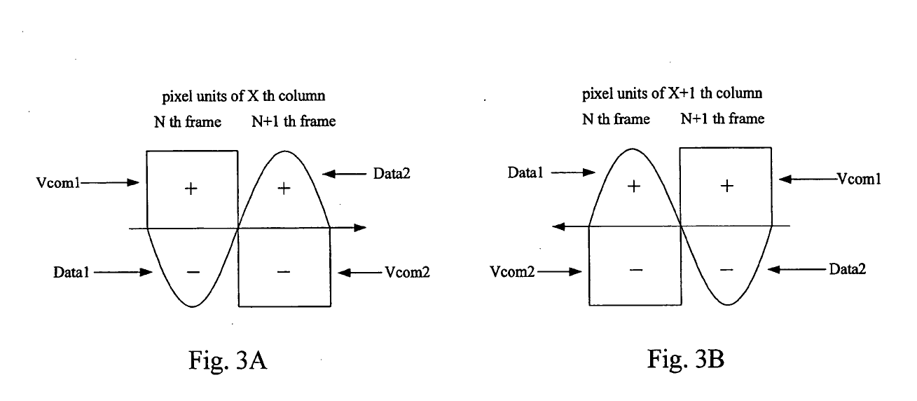

FIGS. 3A and 3B collectively show a diagram of a common voltage and the data signal of an embodiment of the present invention. Take the X-th column of pixel units and the neighboring (X+1)-th column of pixel units as an example, Vcom1 can be a positive voltage (e.g. 5V) and Vcom2 can be a negative voltage (e.g. a 0 v or a voltage under 0 v) in the N-th frame. In the other embodiment, Vcom1 and Vcom2 can also be negative voltage and positive voltage, respectively. The signal Data1 and Data2 with opposite polarity can be alternately transferred to the signal line connected by the transfer pad 208a, 208c, 208e, 208g and 208b, 208d, and 208f. Specifically, Data1 can be transferred to the first group of pixel units 202A, and Data2 can be transferred to the second group of pixel units 202B. The polarity of Vcom1 and Data1 of the pixel units of the X-th column of the N-th frame are different, and thus the range of the voltage can be reduced (e.g. when Data1 with the swing during 0 to −5V are on Vcom1, Data1 actually swings between 0 to 5V). The polarity of Vcom2 and Data2 of the pixel units of the (X+1)-th column of the N-th frame are different, and thus the range of the voltage swing can be kept between 0 to 5V.

The polarity of Vcom1 and Vcom2 and the polarity of Data1 and Data2 are inverted in the (N+1)-th frame. Thus, the inversion can be accomplished with a smaller range of voltage. When two AC voltages (Vcom1 and Vcom2) with opposite polarity are connected to the corresponding pixel units, the inversion can be accomplished with a smaller range of voltage. The use of the source driver used in higher range of voltage can be avoided to lower the cost of production and the temperature of the chip in operation.

The liquid crystal display panel of the present invention can be adopted in a liquid crystal display. The liquid crystal display comprises the liquid crystal display panel described above, and a common voltage driver used to provide a first AC voltage and a second AC voltage respectively.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A liquid crystal display panel comprising:
a plurality of pixel units arranged in an array structure comprising a first group of pixel units and a second group of pixel units;
a first common voltage region with a first alternating current voltage electrically connected to the first group of pixel units; and
a second common voltage region with a second alternating current voltage electrically connected to the second group of pixel units.

2. The liquid crystal display panel of claim 1, wherein the first common voltage region is electrically connected to a first conducting material, and the second common voltage region is electrically connected to a second conducting material.

3. The liquid crystal display panel of claim 2, further comprising a transfer pad, wherein the first and second common voltage regions are electrically connected to the first and the second conducting material through the transfer pad.

4. The liquid crystal display panel of claim 2, wherein the first common voltage region and the second common voltage region are electrically isolated.

5. The liquid crystal display panel of claim 3, wherein the first conducting material and the second conducting material are arranged on the pixel units in an interlaced manner, and the corresponding first and the second common voltage regions are connected to the pixel units.

6. The liquid crystal display panel of claim 2, wherein the first and second common voltage regions comprise conducting glass.

7. The liquid crystal display panel of claim 1, wherein a first capacitance common electrode of one of the every two neighboring pixel units is electrically connected to the first conducting material, and a second lo capacitance common electrode of the other pixel unit is electrically connected to the second conducting material.

8. The liquid crystal display panel of claim 1, wherein a first capacitance common electrode of every one of the two neighboring column of the pixel units is electrically connect to the first conducting material, and a second capacitance common electrode of the other column of the pixel unit is electrically connected to the second conducting material.

9. The liquid crystal display panel of claim 1, wherein a first capacitance common electrode of every one of the two neighboring row of the pixel units is electrically connect to the first conducting material, and a second capacitance common electrode of the other row of the pixel unit is electrically connected to the second conducting material.

10. A liquid crystal display comprising:
a liquid crystal display panel comprising:
a plurality of pixel units arranged in an array structure comprising a first group of pixel units and a second group of pixel units;
a first common voltage region with a first alternating current voltage electrically connected to the first group of pixel units; and
a second common voltage region with a second alternating current voltage electrically connected to the second group of pixel units; and
a plurality of common voltage driver for providing the first alternating current voltage and the second alternating current voltage.

11. The liquid crystal display of claim 9, wherein the first common voltage region is electrically connected to a first conducting material, and the second common voltage region is electrically connected to a second conducting material.

12. The liquid crystal display of claim 10, further comprising a transfer pad, wherein the first and second common voltage regions are electrically connected to the first and the second conducting material through the transfer pad.

13. The liquid crystal display of claim 10, wherein the first common voltage region and the second common voltage region are electrically isolated.

14. The liquid crystal display panel of claim 11, wherein the first conducting material and the second conducting material are arranged on the pixel units in an interlaced manner, and the corresponding first and the second common voltage regions are connected to the pixel units.

15. The liquid crystal display panel of claim 10, wherein the first and second common voltage regions comprise conducting glass.

16. The liquid crystal display panel of claim 9, wherein a first capacitance common electrode of every one of the two neighboring pixel units is electrically connected to the first conducting material and a second capacitance common electrode of the other pixel unit is electrically connected to the second conducting material.

17. The liquid crystal display panel of claim 9, wherein a first capacitance common electrode of every one of the two neighboring column of the pixel units is electrically connect to the first conducting material and a second capacitance common electrode of the other column of the pixel unit is electrically connected to the second conducting material.

18. The liquid crystal display panel of claim 9, wherein a first capacitance common electrode of every one of the two neighboring row of the pixel units is electrically connected to the first conducting material and a second capacitance common electrode of the other row of the pixel unit is electrically connected to the second conducting material.
